(19) United States
(12) Patent Application Publication
(10) Pub. No.: US 2013/0258220 A1
(43) Pub. Date: Oct. 3, 2013

(54) CHOLESTERIC LIQUID CRYSTAL DISPLAY DEVICE AND METHOD FOR CONTROLLING DRIVE OF CHOLESTERIC LIQUID CRYSTAL DISPLAY ELEMENT

(71) Applicant: FUJITSU LIMITED, Kawasaki-shi (JP)

(72) Inventor: Hirokata UEHARA, Kawasaki (JP)

(73) Assignee: FUJITSU LIMITED, Kawasaki-shi (JP)

(21) Appl. No.: 13/683,877

(22) Filed: Nov. 21, 2012

(30) Foreign Application Priority Data
Mar. 29, 2012 (JP) 2012-076768

(51) Int. Cl. G02F 1/133

(52) U.S. Cl. CPC G02F 1/13306
USPC 349/33

(57) ABSTRACT

A cholesteric liquid crystal display device includes a passive matrix cholesteric liquid crystal display element, a drive circuit configured to apply a voltage pulse by a dynamic driving scheme to the cholesteric liquid crystal display element, an electrostatic capacitance detection circuit configured to detect the electrostatic capacitance of the display element; and a drive condition adjustment circuit configured to set a display state by driving the display element under a predetermined drive condition and then to adjust the drive condition of the display element based on the electrostatic capacitance of the display element detected by the electrostatic capacitance detection circuit, wherein the drive condition adjustment circuit searches for and determines an optimum evolution voltage with a temporarily-determined number of pulses during an evolution period and then searches for and determines an optimum value of the number of pulses during the evolution period with the determined evolution voltage.

### CROSS-REFERENCE TO RELATED APPLICATION

This application is based upon and claims the benefit of priority of the prior Japanese Patent Application No. 2012-076768, filed on Mar. 29, 2012, the entire contents of which are incorporated herein by reference.

### FIELD

The disclosed technique relates to a cholesteric liquid crystal display device and a method for controlling the drive of a cholesteric liquid crystal display element.

### BACKGROUND

As a display element, a display element that uses a cholesteric liquid crystal having a memory property has been developed and applied to electronic paper, etc. The display element using a cholesteric liquid crystal may take a planer state in which light having a specific wavelength is reflected, a focal conic state in which light passes through, and an intermediate state between the planar state and the focal conic state by adjusting the strength of an electric field to be applied and an image is displayed by setting the liquid crystal of each pixel to any of the states.

As a method for driving a liquid crystal display element, passive matrix and active matrix are known. In general, the display element making use of the cholesteric liquid crystal has a passive matrix configuration and is driven by the passive matrix drive method because of the manufacturing cost, etc. The passive matrix liquid crystal display element has an upper side substrate on which a plurality of upper side electrodes is provided in parallel, a lower side substrate on which a plurality of lower side electrodes is provided in parallel, and a liquid crystal layer in which the cholesteric liquid crystal is sealed between the upper side electrode and the lower side electrode arranged so as to be orthogonal to each other.

In the passive matrix drive method, a segment driver drives one of the upper side electrode and the lower side electrode and a common driver drives the other. The electrode driven by the segment driver is referred to as a segment electrode and the electrode driven by the common driver is referred to as a common electrode.

The drive method of the passive matrix cholesteric liquid crystal display element is roughly divided into two, i.e., the conventional drive method and the dynamic driving method. With the conventional drive method, it is possible to produce a precise gradation display, however, there is a problem that the rewrite of the display takes a long time. On the other hand, with the dynamic drive method, it is possible to rewrite a display at a comparatively high speed, however, there is a problem that it is difficult to produce a precise gradation display.

In electronic paper, the contrast, brightness, gamma characteristic, etc., of the display element tend to vary between lots because of the very difficult manufacturing process using a film substrate. After manufacturing, these characteristics may change due to long term use of the display element. If there are such variations and secular change, there arises such a problem that a desirable display is not produced even if the display element is driven under the same condition.

Because of the above, it has been proposed to perform automatic adjustment so that an optimum drive condition is obtained by detecting variations between lots of the display elements and the secular change.

For example, it has been proposed adjust so that a desired display state is obtained by mounting a luminance sensor on the display element and by detecting the actual display state. However, mounting a luminance sensor on the display element is problematic from the standpoint of the cost and appearance and in particular, it is preferable not to mount a luminance sensor on a reflection-type display element that is easy to carry, such as electronic paper.

Further, measuring the accumulated energization time of a display element that is energized at all times during the period of display and to perform correction by estimating the secular change is also carried out. However, the electronic paper is energized only when being rewritten and the energization is random, and therefore, the correction that makes use of the accumulated energization time is not adequate for the electronic paper.

To drive a liquid crystal display element is to drive each pixel having an electrostatic capacitance and the drive condition is determined in accordance with the electrostatic capacitance value. Because of this, it is providing a dummy pixel and adjust the drive voltage by detecting the electrostatic capacitance value of the dummy pixel has been proposed. However, the electrostatic capacitance of the dummy pixel does not agree with the electrostatic capacitance of an actual display pixel because of the difference in the drive history, and therefore, there is a problem that the detection precision is not sufficient. Further, in the proposed method, the electrostatic capacitance value is detected by detecting the oscillation frequency of a CR oscillator circuit including dummy pixels. This detection method is practical when the specific resistance is high and the capacitance characteristic is stable, such as in a liquid crystal used in an active matrix type liquid crystal display element, however, when the specific resistance is relatively low and the capacitance characteristic is unstable, such as in the cholesteric liquid crystal having the memory property used in the electronic paper, the stability of the oscillator circuit is insufficient and it is not possible to detect the electrostatic capacitance with high precision.

It is known that the electrostatic capacitance of the liquid crystal display element changes in accordance with temperature. In other words, the electrostatic capacitance changes in accordance with temperature and in response to this, the drive condition changes accordingly. Therefore, it is proposed to obtain an excellent display at all times regardless of temperature by detecting the electrostatic capacitance of the display element and by adjusting the drive condition. However, this proposal takes into consideration only the adjustment in accordance with temperature but not variations or the secular change.

### RELATED DOCUMENTS

[Patent Document 1] Japanese Laid Open Patent Document No. 2008-065058
[Patent Document 2] Japanese Laid Open Patent Document No. S52-140295
[Patent Document 3] U.S. Pat. No. 5,453,863
[Patent Document 4] U.S. Pat. No. 5,748,277
[Non-Patent Document 1] J. Ruth, et. al.: “LOW COST DYNAMIC DRIVE SCHEME FOR REFLECTIVE BISTABLE CHOLESTERIC LIQUID CRYSTAL DISPLAYS”, Flat Panel Display '97.

### SUMMARY

According to an aspect of the embodiments, a cholesteric liquid crystal display device includes: a passive matrix type cholesteric liquid crystal display element; a drive circuit configured to apply a voltage pulse by a dynamic driving scheme to the cholesteric liquid crystal display element so as to produce a display in accordance with display data; an electrostatic capacitance detection circuit configured to detect the electrostatic capacitance exhibited by the display element; and a drive condition adjustment circuit configured to set a display state by driving the display element under a predetermined drive condition and then to adjust the drive condition of the display element based on the electrostatic capacitance of the display element exhibiting the display state detected by the electrostatic capacitance detection circuit, wherein the drive condition adjustment circuit searches for and determines an optimum evolution voltage with a temporarily-determined number of pulses during an evolution period and then searches for and determines an optimum value of the number of pulses during the evolution period with the determined evolution voltage.

The object and advantages of the embodiments will be realized and attained by means of the elements and combination particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating an outline of a configuration of a display device of an embodiment;

FIG. 2 is a diagram illustrating a configuration of the display element used in the display device of the embodiment;

FIG. 3 is a diagram illustrating a basic configuration of one panel;

FIG. 4A and FIG. 4B are diagrams each explaining the state of the cholesteric liquid crystal;

FIG. 5 is a diagram illustrating an example of the voltage-reflection characteristic of the general cholesteric liquid crystal;

FIG. 6 is a diagram illustrating a drive waveform in DDS;

FIG. 7 is a diagram illustrating drive waveforms that a common driver outputs during a Preparation period, a Selection period, an Evolution period, and a Non-Select period, drive waveforms that a segment driver outputs for the white display and the black display, and waveforms to be applied to the liquid crystal;

FIG. 8 is a diagram more specifically illustrating a voltage waveform to be applied to each pixel liquid crystal as a result of the common driver and the segment driver outputting the drive waveforms illustrated in FIG. 7 in the embodiments;

FIGS. 9A to 9C are diagrams explaining a scan operation in the display device of the embodiments;

FIG. 10A is a diagram illustrating the way “F” is written;

FIG. 10B is a diagram illustrating a distribution of voltage waveforms applied to each pixel in the state of FIG. 10A;

FIG. 11 is a diagram illustrating an example of a difference between individual display elements of the characteristic illustrating the relationship between the pulse voltage (Evolution voltage) during the Evolution period and the brightness in the dynamic driving scheme;

FIG. 12 is a diagram illustrating the result of measurement of the relationship between the reflectance (brightness) and the electrostatic capacitance of five samples of the display element;

FIG. 13 is a diagram illustrating the frequency characteristic of electrostatic capacitance of the display element;

FIG. 14 is a diagram illustrating the configuration of a circuit part that outputs an electrostatic capacitance detection signal in a power source unit, a current sense amplifier, and an arithmetic unit;

FIG. 15 is a diagram illustrating a waveform of an electrostatic capacitance detection signal to be supplied to an unused power source terminal of the segment driver from a booster circuit via a damping resistor;

FIGS. 16A and 16B are diagrams illustrating the result of the experiment of the detection of the electrostatic capacitance with the circuit configuration of FIG. 14 by using a test cell of cholesteric liquid crystal;

FIG. 17 is a diagram illustrating a change in contrast ratio of white and black (on and off) displays when varying the Evolution voltage after setting the Evolution pulse number to a plurality of different values between 60 and 120 and by setting the width of the Selection pulse to a plurality of different values between 0.7 and 0.85 ms in the display device of the embodiment;

FIG. 18 is a diagram illustrating a change in contrast ratio of white and black displays when varying the Evolution pulse number and the Selection pulse width after setting the Evolution voltage to a predetermined value near 21.3 V at which the maximum contrast ratio is obtained;

FIG. 19 is a flowchart illustrating adjustment processing of the drive condition in the display device of the embodiment;

FIGS. 20A and 20B are diagrams explaining a three-way classification.

### DESCRIPTION OF EMBODIMENTS

Hereinafter, embodiments are explained specifically with reference to the drawings.

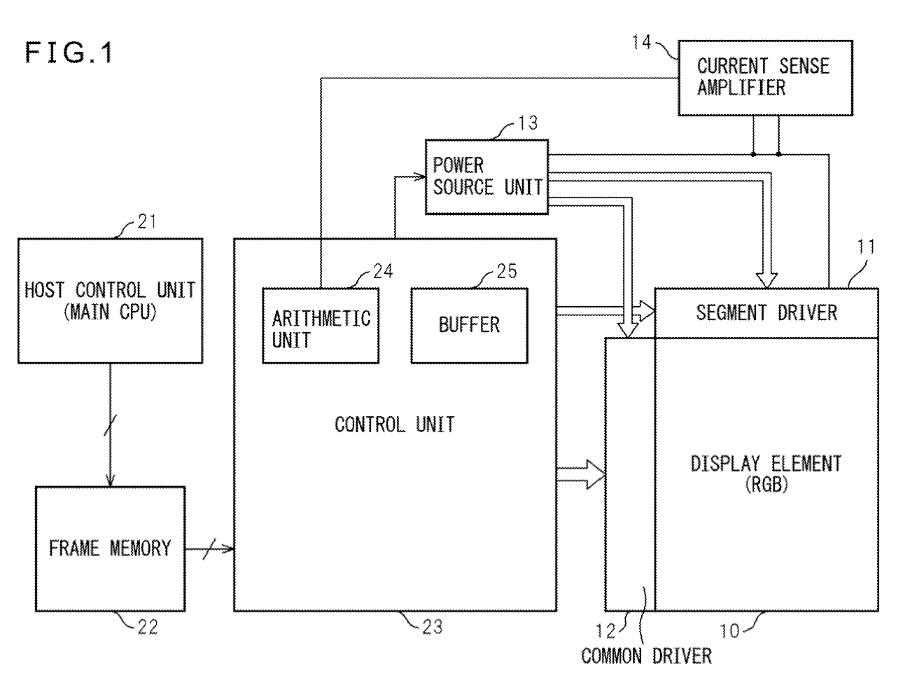

FIG. 1 is a diagram illustrating an outline of a configuration of a display device of an embodiment. The display device of the embodiment is electronic paper. To a display element 10, a drive signal is applied only when a display is rewritten and the display once rewritten is held even if a drive signal is not applied.

As illustrated in FIG. 1, the display device of the embodiment has the display element 10 using the cholesteric liquid crystal, a segment driver 11, a common driver 12, a power source unit 13, a current sense amplifier 14, a host control unit 21, a frame memory 22, and a control unit 23.

The host control unit has a main CPU etc. and performs various kinds of processing on image data stored in an external storage device and on image data obtained via a communication circuit to form an image suitable for the display on this display device. For example, when displaying halftone image data, the host control unit 21 performs gradation conversion by applying the publicly-known gradation conversion, such as the error diffusion method, the organic dither method, and the blue noise mask method, so that the number of gradations thereof is suitable to that which may be displayed by this display device. There is a case where part of the processing is performed by the control unit 23. The host control unit 21 stores the generated image data in the frame memory 22.

The control unit 23 has a sub CPU, a microcontroller, or PLD, etc., and performs control of each unit, except for the host control unit 21. The control unit 23 generates drive data in accordance with the image data read from the frame memory 22 and supplies the drive data to the segment driver 11 and the common driver 12. It is desirable for the control unit 23 to have a buffer 25 configured to temporarily store the generated drive data in order to make easy the timing adjustment of supply of the drive data to the segment driver 11 and the common driver 12.

The display element 10 is a display element using the cholesteric liquid crystal, in which three layer panels of RGB are stacked, and capable of producing a color display. Details of the display element 10 will be described later. The segment driver 11 and the common driver 12 drive the display element by the passive matrix scheme and are implemented by a general-purpose driver IC. Here, the segment driver 11 includes three drivers and drives the panel of each layer independently, however, it is also possible for the common driver 12 to drive the panels of the three layer in common by one driver.

The power source unit 13 steps up a voltage of 3 to 5 V supplied from a common power source, not illustrated schematically, to +50 V by a step-up regulator, such as a DC-DC converter, in the case of a monopole driver IC and to about −25 V to +25 V using also a negative DC-DC converter in the case of a bipolar driver IC. It is of course desirable for the step-up regulator to have a high conversion efficiency for the characteristic of the display element. It is desirable to switch between the reset voltage and the write voltage using an analog switch, a digital potentiometer, etc. In the subsequent stage of the switching circuit, a booster circuit including an operational amplifier and a transistor, and a smoothing capacitor are arranged in order to stabilize the drive voltage of the display element 10.

The configuration explained above is the same as that of the display device using a general cholesteric liquid crystal and it is possible to apply various configurations known hitherto.

In the display device of the embodiment, the power source unit 13 generates an electrostatic capacitance detection signal, such as a sawtooth wave signal and a triangular wave signal, in response to the control signal from the control unit 23 and supplies the electrostatic capacitance detection signal to the power source terminal of the segment driver 11. It is preferable to use a part of the power source terminal that is not used for write etc. Further, it is possible for the power source unit 13 to adjust the voltage to be supplied to the segment driver 11 and the common driver 12 in response to the control signal from the control unit 23.

In the display device of the embodiment, further, the current sense amplifier 14 is arranged so as to detect the current of the signal line used to supply the electrostatic capacitance detection signal from the power source unit 13 to the segment driver 11. The current detected when the electrostatic capacitance detection signal is applied to the display element 10 is in relation to the electrostatic capacitance of the display element 10 and the current sense amplifier 14 outputs the detection signal to an arithmetic unit 24.

The control unit 23 adjusts the drive condition mode at the time of activation of the display device or in response to the instruction of a user. It may also be possible to adjust the drive condition mode without exception when the display device is used for the first time, such as at the time of shipping of the product, and to automatically adjust periodically after that, for example at the frequency of about once a month. After setting the display element 10 to a predetermined display state, the control unit 23 applies the electrostatic capacitance detection signal to the display element 10 from the power source unit 13 and the arithmetic unit 24 controls to digitize the detection signal of the current sense amplifier 14 to take in as detection data. The arithmetic unit 24 acquires the detection data while changing the display state of the display element 10 in accordance with a drive condition adjustment sequence, to be described later, and determines a drive condition under which a desired display may be produced. After the drive condition adjustment mode is completed, the control unit 23 controls each unit in accordance with the determined drive condition.

Next, a display device using a cholesteric liquid crystal used as the display element 10 in the display device of the embodiment is explained.

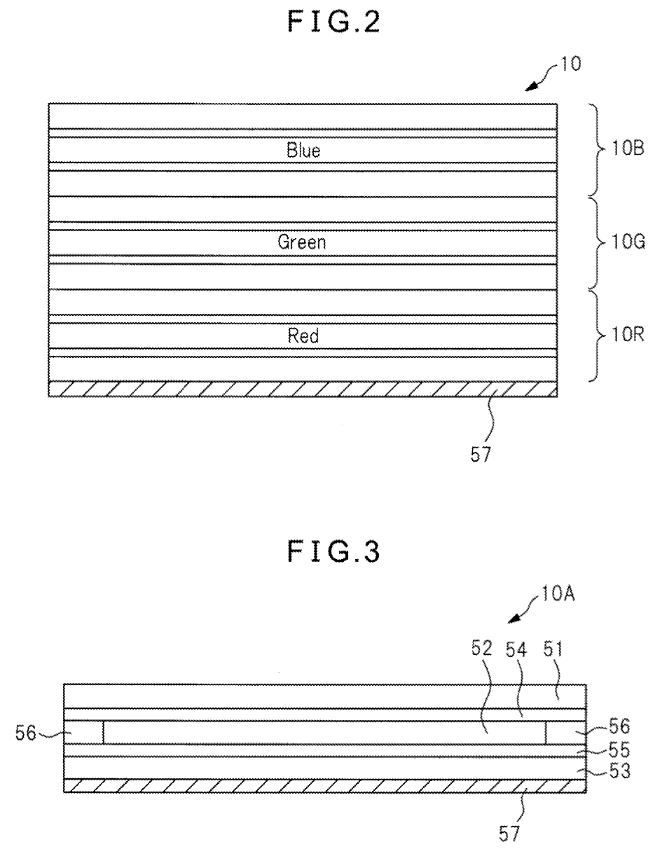

FIG. 2 is a diagram illustrating a configuration of the display element 10 used in the display device of the embodiment. As illustrated in FIG. 2, in the display element 10, three panels, that is, a blue panel 10B, a green panel 10G, and a red panel 1OR are stacked in the order from the viewing side. Under the red panel 10R, a light absorbing layer 57 is provided. The panels 10B, 10G, and 1OR have the same configuration, however, the liquid crystal material and chiral material are selected and the content percentage of the chiral material is determined so that the center wavelength of reflection of the panel 10B is blue (about 480 nm), the center wavelength of reflection of the panel 10G is green (about 550 nm), and the center wavelength of reflection of the panel 10R is red (about 630 nm). The scan electrode and the data electrode of the panels 10B, 10G, and 10R are driven by the common driver 12 and the segment driver 11.

The panels 10B, 10G, and 10R have the same configuration except in that the center wavelengths of reflection are different. Hereinafter, a typical example of the panels 10B, 10G, and 10R is represented by a panel 10A and the configuration thereof is explained.

FIG. 3 is a diagram illustrating a basic configuration of one panel 10A.

As illustrated in FIG. 3, the display panel 10A has an upper side substrate 51, an upper side electrode layer 64 provided on the surface of the upper side substrate 51, a lower side electrode layer 55 provided on the surface of a lower side substrate 53, and a seal material 56. The upper side substrate 51 and the lower side substrate 53 are arranged so that the electrodes are in opposition to each other and after a liquid crystal material is sealed therebetween, both substrates are sealed with the seal material 56. Within a liquid layer 52, a spacer is arranged, however, not illustrated schematically. To the electrodes of the upper side electrode layer 54 and the lower side electrode layer 55, a voltage pulse signal is applied and thereby a voltage is applied to the liquid crystal layer 52. A display is produced by applying a voltage to the liquid crystal layer 52 to bring the liquid crystal molecules of the liquid crystal layer 52 into the planar state or the focal conic state. A plurality of scan electrodes and a plurality of data electrodes are formed in the upper side electrode layer 54 and the lower side electrode layer 55.

Although both the upper side substrate 51 and the lower side substrate 53 have transparency, the lower side substrate 53 of the panel 10R may be opaque. As a substrate having transparency, mention is made of a glass substrate, however, a film substrate made of PET (polyethylene terephthalate) or PC (polycarbonate) may be used besides the glass substrate.

As a material of the electrode of the upper side electrode layer 54 and the lower side electrode layer 55, for example, indium tin oxide (ITO) is typical, however, a transparent conductive film made of indium zinc oxide (IZO) may also be used.

The transparent electrode of the upper side electrode layer 54 is formed as a plurality of belt-like upper side transparent electrodes parallel to one another on the upper side substrate 51 and the transparent electrode of the lower side electrode layer 55 is formed as a plurality of belt-like lower side transparent electrodes parallel to one another on the lower side substrate 53. Then, the upper side substrate 51 and the lower side substrate 53 are arranged so that the upper side electrode and the lower side electrode intersect when viewed from the direction perpendicular to the substrate and a pixel is formed at the intersection. An insulating thin film is formed on the electrode. If the thin film is thick, the drive voltage is increased. Conversely, if there is no thin film, a leak current flows and there arises such a problem that the precision of the automatic adjustment is reduced. The thin film has a relative dielectric constant of about 5, which is considerably lower than that of the liquid crystal, and therefore, it is appropriate to set the thickness of the thin film to about 0.3 μm or less.

It is possible to implement the insulating thin film by a thin film of SiO₂, or an organic film, such as one made of polyimide resin and acryl resin, which is known as an orientation-stabilized film.

As described above, a spacer is arranged within the liquid crystal layer 52 and the distance between the upper side substrate 51 and the lower side substrate 53, i.e., the thickness of the liquid crystal layer 52 is made constant. The spacer is a spherical body made of, in general, resin or inorganic oxide, however, it is also possible to use a fixed spacer coated with thermoplastic resin on the surface of the substrate. The cell gap formed by this spacer is appropriate when in a range of 4 μm to 6 μm. If the cell gap is less than this value, the reflectance is reduced and a dark display is produced, and therefore, a high threshold steepness is not expected. Conversely, if the cell gap is larger than this value, a high threshold steepness may be held, however, it is difficult to drive by a general-purpose part because the drive voltage is increased.

The liquid crystal composition that forms the liquid crystal layer 52 is a cholesteric liquid crystal, which is a nematic liquid crystal mixture to which a chiral material of 10 to 40 wt % is added. The amount of the chiral material to be added is the value when the total amount of the nematic liquid crystal component and the chiral material is assumed to be 100 wt %.

As a nematic liquid crystal, various kind of nematic liquid crystal publicly-known conventionally may be used, however, it is desirable that the nematic liquid crystal be a liquid crystal material the dielectric constant anisotropy (Δε) of which is in a range of 15 to 35. If the dielectric constant anisotropy is 15 or less, the drive voltage becomes generally high and it becomes difficult to use a general-purpose part in the drive circuit.

On the other hand, if the dielectric constant anisotropy becomes 25 or more, the threshold steepness is reduced and further, there occurs an apprehension that the reliability of the liquid crystal material itself is reduced.

It is desirable that the refractive index anisotropy (Δn) be between 0.18 and 0.24 and if the refractive index anisotropy is smaller than this range, the reflectance in the planar state is reduced and if larger than this range, in addition to an increase in magnitude of scattering reflection in the focal conic state, the viscosity is raised and the response rate is reduced.

Next, bright and dark (white and black) displays in the display device using a cholesteric liquid crystal are explained. In the display device using a cholesteric liquid crystal, the display is controlled by the orientation state of liquid crystal molecules.

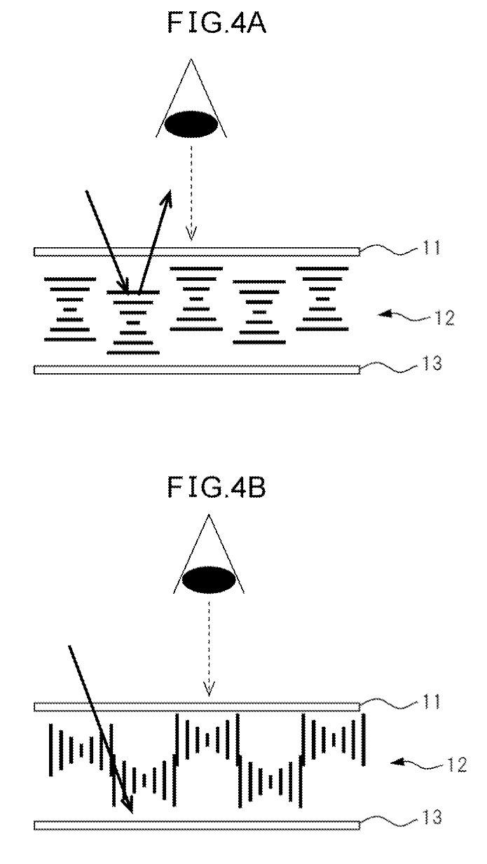

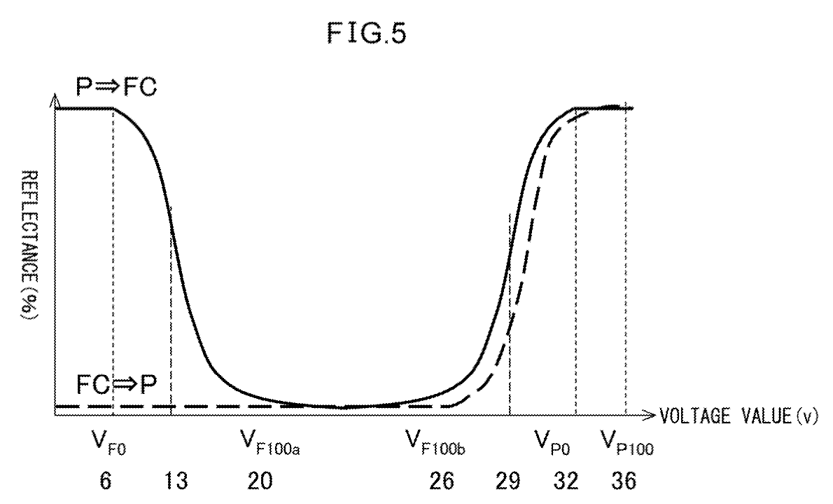

FIG. 4A and FIG. 4B are diagrams each explaining the state of the cholesteric liquid crystal. The cholesteric liquid crystal has the planar state in which incident light is reflected as illustrated in FIG. 4A and the focal conic state in which incident light passes through as illustrated in FIG. 4B and these states are kept even under no electric field. Besides, there is a homeotropic state in which all liquid crystal molecules align with the orientation of the electric field when a strong electric field is applied and the homeotropic state turns to the planar state or the focal conic state when application of the electric field is stopped.

In the planar state, light having a wavelength in accordance with the helical pitch of liquid crystal molecules is reflected. A wavelength λ with which the reflection is at its maximum is expressed by the following expression:

λ=n·p

where n represents the average refractive index of the liquid crystal and P represents the helical pitch.

On the other hand, a reflection band Δλ increases as a refractive index anisotropy Δn of liquid crystal increases.

In the planar state, incident light is reflected, and therefore, the “bright” state, that is white, may be displayed. On the other hand, in the focal conic state, light having passed through the liquid crystal layer is absorbed by providing a light absorbing layer under the lower side substrate 53, and therefore, the “dark” state, that is black may be displayed. In the state where the planar state and the focal conic state exist mixedly, a halftone state between the “bright” state “(white display) and the “dark” state (black display) is brought about and the halftone level is determined by a mixture ratio of the planar state and the focal conic state.

Next, a drive method of a display element that makes use of a cholesteric liquid crystal is explained.

FIG. 5 illustrates an example of the voltage-reflection characteristic of the general cholesteric liquid crystal. The horizontal axis represents the voltage value (V) of a pulse voltage to be applied with a predetermined pulse width between electrodes that sandwich the cholesteric liquid crystal and the vertical axis represents the reflectance (%) of the cholesteric liquid crystal. In FIG. 5, a solid curved line P represents the voltage-reflectance characteristic of the cholesteric liquid crystal when the initial state is the planar state and a broken curved line FC represents the voltage-reflectance characteristic of the cholesteric liquid crystal when the initial state is the focal conic state.

If a strong electric field (VP 100 or more) is generated in the cholesteric liquid crystal, the helical structure of the liquid crystal molecules is completed untied during the application of the electric field and a homeotropic state is brought about where all the molecules align with the direction of the electric field. Next, when the liquid crystal molecules are in the homeotropic state, if the applied voltage is rapidly reduce to substantially zero from VP100, the helical axis of the liquid crystal becomes perpendicular to the electrode and the planar state is brought about where light in accordance with the helical pitch is reflected selectively.

On the other hand, after applying an electric field so weak that the helical structure of the liquid crystal molecules is not untied (in a range between VF 100a and VF 100b), if the electric field is removed gradually from this state by removing the electric field or applying a strong electric field, the helical axis of the liquid crystal molecules becomes parallel to the electrode and the focal conic state is brought about where incident light passes through.

Further, if an electric field of intermediate strength (VF0 to VF100 or VF100b to VP0) is applied and then the electric field is removed rapidly, the planar state and the focal conic state coexist mixedly and it is made possible to display a halftone image.

A display is produce by making use of the above phenomenon.

In the passive matrix type display device using the cholesteric liquid crystal, when high-speed write is performed, the dynamic driving scheme (DDS) is used. In the display device of the embodiment, a display of a halftone image display is produced also by DDS. It may also be possible to perform the reset operation to bring all the pixels into the planar state at the same time before rewriting an image. The reset operation is performed by forcedly turning all the outputs of the segment driver 11 and the common driver 12 to a predetermined voltage value, respectively, and transfer of data to set the output value is not carried out, and therefore, it is possible to perform the reset operation in a brief time. However, the reset operation consumes power, and therefore, the reset operation in a device of low power consumption is not performed.

In order to make explanation easy, a case is explained where a two-valued image of white and black is displayed.

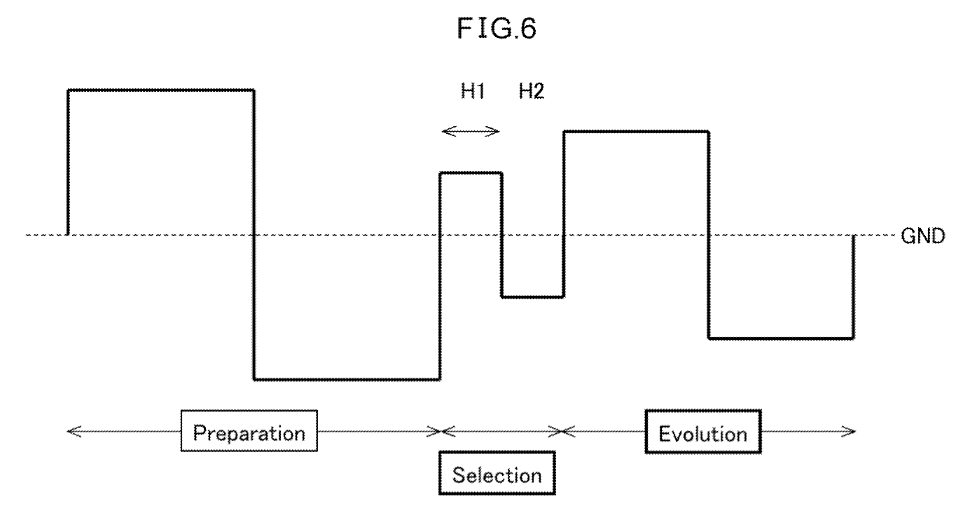

FIG. 6 is a diagram illustrating a drive waveform in DDS.

As described previously, DDS is roughly divided into three stages and includes, from the forefront, a “Preparation” period, a “Selection” period, and an “Evolution” period. Before and after these periods, a Non-Select period is provided. The Preparation period is a period during which the liquid crystal is initialized to the homeotropic state and a Preparation pulse having a high voltage and a great pulse width is applied. The Selection period is a period during which a trigger to branch into the planar state or the focal conic state is given. During the Selection period, a Selection pulse having a low voltage and a narrow pulse width is applied to switch the state to the planar state and no pulse is applied to switch the state to the focal conic state. The Evolution period is a period during which the planar state or the focal conic state is settled in accordance with the transition state during the immediately previous Selection period and an Evolution pulse having an intermediate voltage and a great pulse width is applied. The Preparation pulse, the Selection pulse, and the Evolution pulse are each a pair of positive and negative pulses.

In fact, during the Preparation period and the Evolution period, a pair of positive and negative pulses having a great pulse width as illustrated in FIG. 6 is not applied but a plurality of positive and negative Preparation pulses and Evolution pulses is applied.

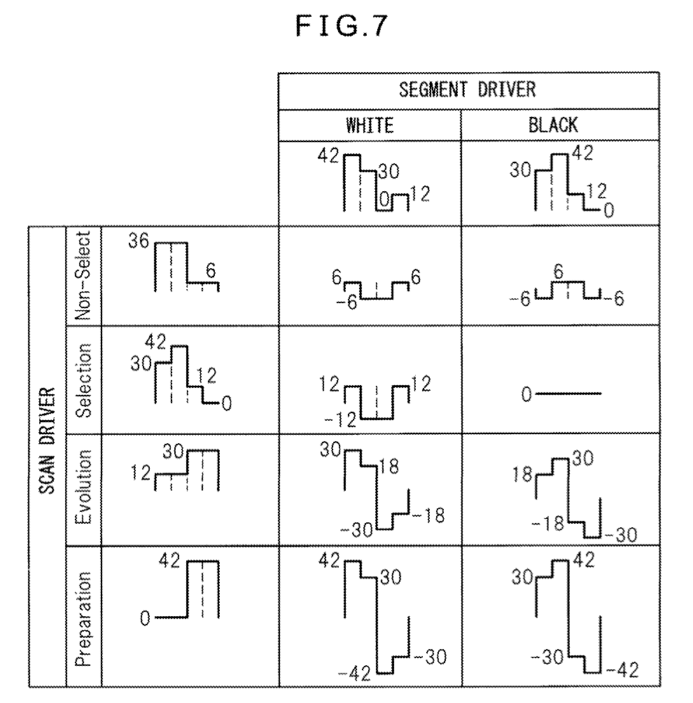

FIG. 7 illustrates drive waveforms that the common driver 12 outputs during the Preparation period, the Selection period, the Evolution period, and the Non-Select period, drive waveforms that the segment driver 11 outputs for the white display and the black display, and waveforms to be applied to the liquid crystal.

When performing DDS in the embodiment, the common driver 12 outputs six values including GND and the segment driver 11 outputs four values including GND. At present, the general-purpose IC of the passive matrix scheme is put to practical use and it is possible to use the general-purpose driver IC as the segment driver 11 or the common driver 12 by setting the mode. Consequently, the general-purpose driver IC made use of as the segment driver 11 has values to be output left unused. In the embodiment, by making use of the output left unused of the segment driver 11, an electrostatic capacitance detection signal is applied to the display element 10.

The common driver 12 and the segment driver 11 change the output in units of periods into which the Selection period is quartered. The segment driver 11 outputs a voltage waveform that changes to 42 V, 30 V, 0 V, and 12 V for the white display and a voltage waveform that changes to 30 V, 42 V, 12 V, and 0 V for the black display. The common driver 12 outputs a voltage waveform that changes to 36 V, 36 V, 6 V, and 6 V during the Non-Select period, a voltage waveform that changes to 30 V, 42 V, 12 V, and 0 V during the Selection period, a voltage waveform that changes to 12 V, 12 V, 30 V, and 30 V during the Evolution period, and a voltage waveform that changes to 0 V, 0 V, 42 V, and 42 V during the Preparation period.

Due to this, during the Preparation period, a voltage waveform that changes to 42 V, 30 V, −42 V, and −30 V is applied to the liquid crystal of the data electrode of the white display and a voltage waveform that changes to 30 V, 42 V, −30 V, and −42 V is applied to the liquid crystal of the data electrode of the black display. During the Evolution period, a voltage waveform that changes to 30 V, 18 V, −30 V, and −18 V is applied to the liquid crystal of the data electrode of the white display and a voltage waveform that changes to 18 V, 30 V, −18 V, and −30 V is applied to the liquid crystal of the data electrode of the black display. During the Selection period, a voltage waveform that changes to 12 V, −12 V, −12 V, and 12 V is applied to the liquid crystal of the data electrode of the white display and a voltage waveform of 0 V is applied to the liquid crystal of the data electrode of the black display. During the Non-Select period, a voltage waveform that changes to 6 V, −6 V, −6 V, and 6 V is applied to the liquid crystal of the data electrode of the white display and a voltage waveform that changes to −6 V, 6 V, 6 V, and −6 V is applied to the liquid crystal of the data electrode of the black display.

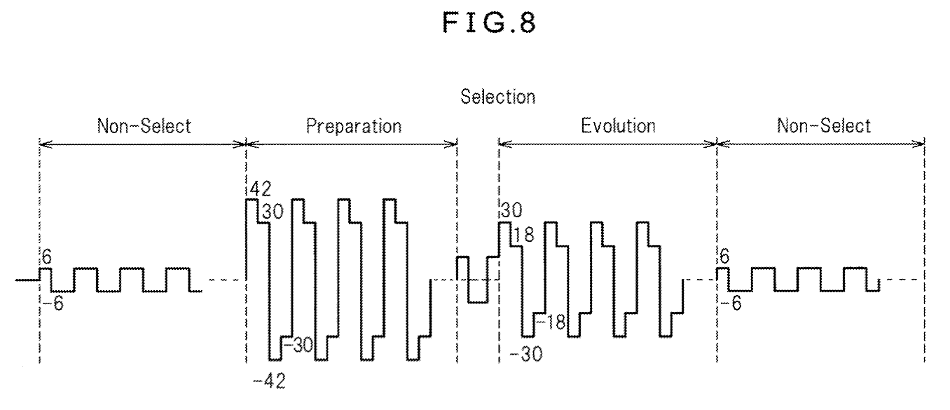

FIG. 8 is a diagram more specifically illustrating a voltage waveform to be applied to each pixel liquid crystal as a result of the common driver 12 and the segment driver 11 outputting the drive waveforms illustrated in FIG. 7 in the embodiment. The voltage waveform of FIG. 8 is applied to one scan line. The common driver 12 shifts the scan line one by one to which the signal of FIG. 8 is applied.

As illustrated in FIG. 8, the Preparation period, the Selection period, and the Evolution period are arranged in this order and before and after these periods, the Non-Select period is arranged. During the Selection period, the application time is about 0.5 ms to 1 ms. FIG. 8 illustrates the Selection pulse of ±12 V when the white display (bright display) is produced in the planar state and when the black display (dark display) is produced in the focal conic state, 0 V is applied during this period.

The lengths of the Preparation period and the Evolution period are about several times to tens of times the length of the Selection period and a plurality of the Preparation pulses and the Evolution pulses of FIG. 7 is applied. A Non-select pulse is a pulse applied at all times to pixels not involved in drawing and which has a low voltage, and therefore, does not change an image.

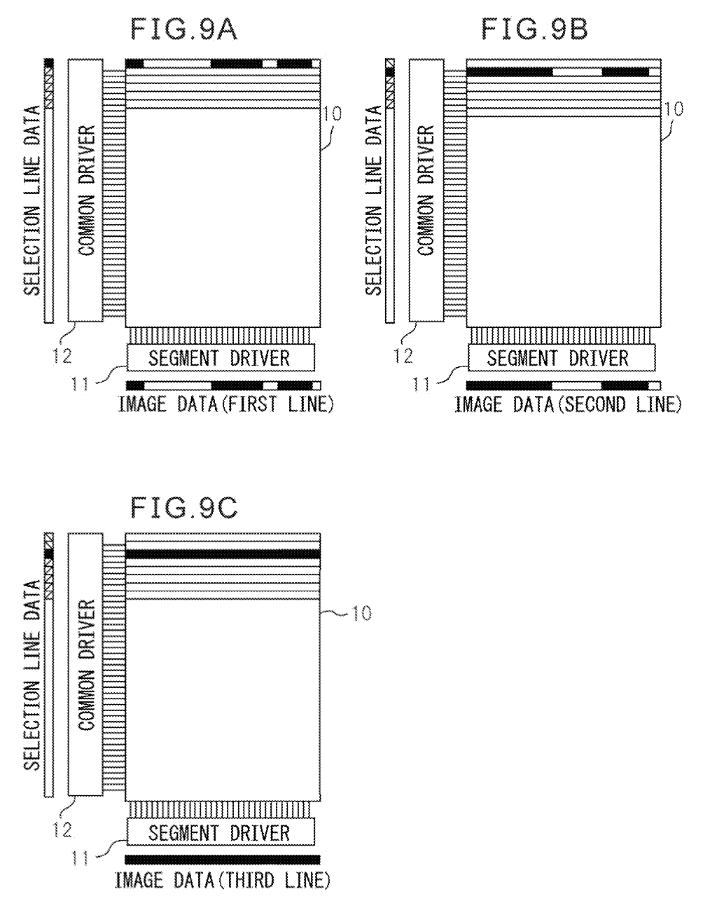

FIG. 9A to FIG. 9C are diagrams explaining the scan operation in the display device of the embodiment. In the display device adopting the passive matrix scheme, the scan electrode is driven by the common driver 12 and the data electrode is driven by the segment driver 11.

FIG. 9A to FIG. 9C each illustrate an example in which the Preparation period and the Evolution period the length of which is five times that of the Selection period are provided before and after the Selection period. FIG. 9A illustrates a case where the zeroth line is the Selection period. In this case, the first to fifth lines are the Preparation period and the lines other than the zeroth to fifth lines are the Non-Select period. FIG. 9B illustrates a case where the first line is the Selection period. In this case, the second to sixth lines are the Preparation period, the zeroth line is the Evolution period, and the lines other than the zeroth to sixth lines are the Non-Select period. FIG. 9C illustrates a case where the second line is the Selection period. In this case, the third to seventh lines are the Preparation period, the zeroth to first lines are the Evolution period, and the lines other than the zeroth to seventh lines are the Non-Select period. In the manner described above, write is performed while shifting the line of the Selection period.

The Preparation period and the Evolution period before and after the Selection period are in the state of the black display and it seems as if a black belt shifts. In the example described above, the lengths of the Preparation period and the Evolution period are illustrated to be five times that of the Selection period, however, in fact, tens of times to one hundred times and while an image is being rewritten, it seems as if a thick black belt shifts.

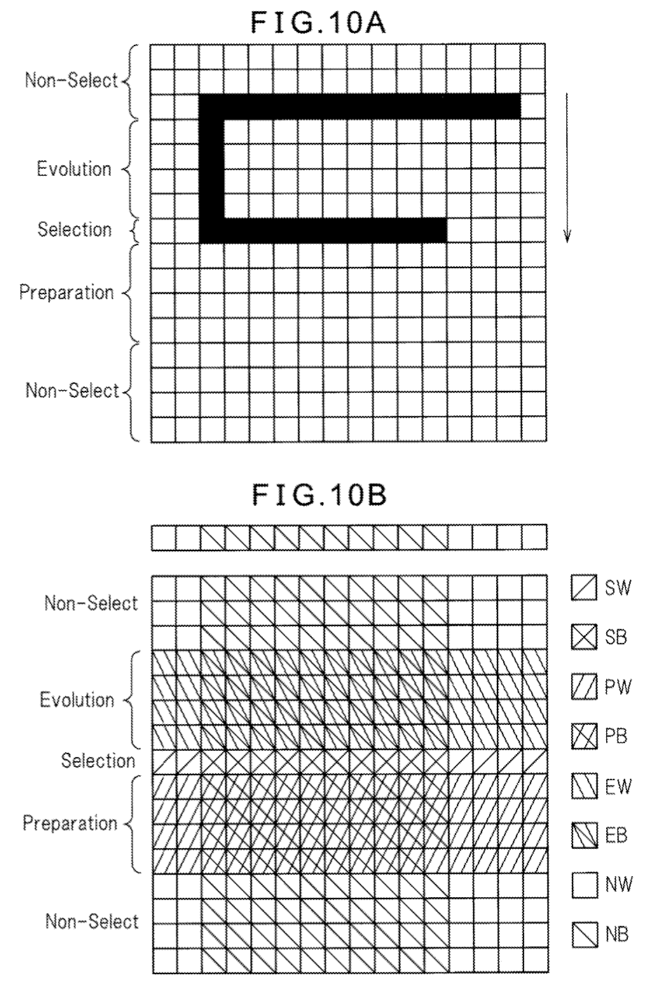

FIG. 10A is a diagram illustrating the way “F” is written. As illustrated in FIG. 10A, in the state where the line of the Selection period advances to a point on the way of writing “F”, the four lines of the Preparation period and the four lines of the Evolution period exist before and after the Selection period and the other lines are the Non-Select period. At this time, the segment driver 11 outputs a voltage signal corresponding to the image (black and white) data of the Selection period.

FIG. 10B is a diagram illustrating a distribution of voltage waveforms applied to each pixel in the state of FIG. 10A. There are eight kinds of waveform applied to a pixel, i.e., four kinds of output of the common driver 12 of the Non-Select period, the Selection period, the Evolution period, and the Preparation period and two kinds of output of the segment driver 11 of the white display and the black display, respectively. These eight kinds of waveforms are represented by NW (Non-Select and white), NB (Non-Select and black), SW (Selection and white), SB (Selection and black), EW (Evolution and white), EB (Evolution and black), PW (Preparation and white), and PB (Preparation and black). As illustrated in FIG. 10B, there are pixels to which the eight kinds of voltage waveform NW, NB, SW, SB, EW, EB, PW, PB are applied.

As described above, in the display device of the embodiment, a set of the Preparation pulse, the Selection pulse, and the Evolution pulse of FIG. 8 is applied sequentially while changing the position of the scan line. Due to this, the Selection pulse, accompanied by the Preparation pulse and the Evolution pulse, performs scan/rewrite in a pipeline manner with the application time of the Selection pulse per line. Because of that, it is possible to perform rewrite at a speed about 1 ms×768=0.77 sec even in the display element of high precision size of the XGA specifications.

When displaying a halftone image, the configuration is designed so that the drive waveforms illustrated in FIG. 7 may be applied during each sub period by further dividing the Selection period into a plurality of sub periods and of the plurality of sub periods, the ratio between the sub periods during which the white display is produced and the sub periods during which the black display is produced is changed. For example, in the case where eight sub periods are provided, when the white display is produced during all the eight sub periods, the duty ratio is 100%, when the black display is produced during all the eight sub periods, the duty ratio is 0%, and when the white display is produced during two sub periods, the duty ratio is 25%, In the embodiment, the Separation period is about 700 μs and divided into sub periods of 20 to 30 μs. Consequently, 23 to 35 sub periods are provided. During the Selection period, if the sub period of the white display is arranged in the center, the width of the Selection pulse of the white display during the Selection period varies according to the duty ratio as a result. In the following, in order to simplify explanation, explanation is given on the assumption that the simplified DDS drive waveform illustrated in FIG. 6 is used and the width of the Selection pulse during the selection period varies according to the duty ratio.

The flexible cholesteric liquid crystal display element used in electronic paper has a manufacture variation in the thickness of the cell gap and the orientation film, and therefore, the characteristic of the display element also varies from element to element. For example, the relationship between the pulse voltage during each period and the brightness that is displayed in the dynamic driving scheme also varies.

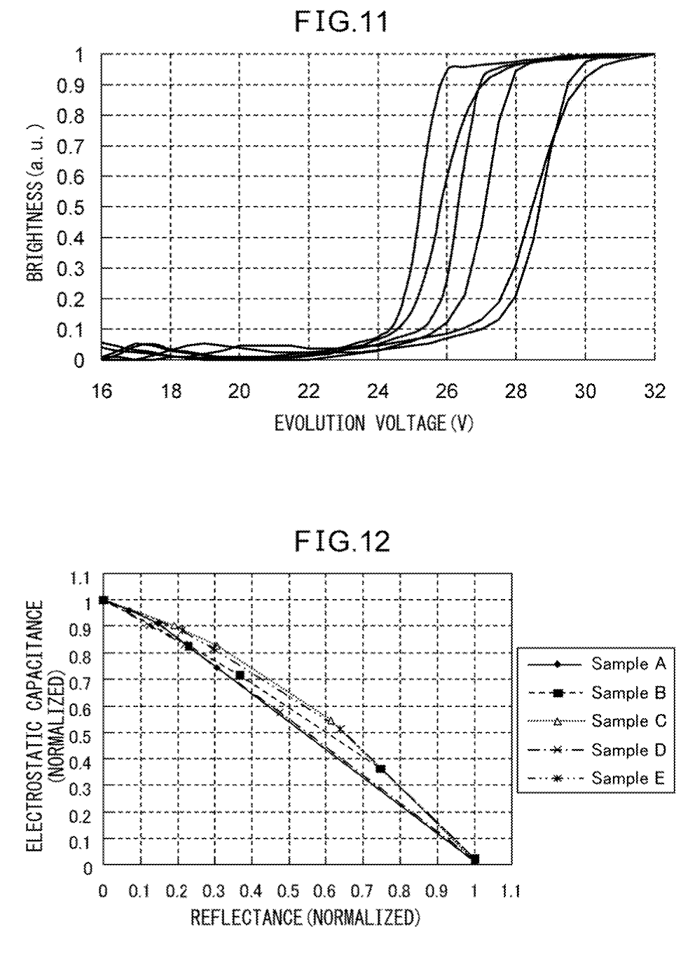

FIG. 11 is a diagram illustrating an example of a difference between individual display elements of the characteristic illustrating the relationship between the pulse voltage (Evolution voltage) during the Evolution period and the brightness in the dynamic driving scheme. The brightness and the gamma characteristic differ from display element to display element, and therefore, even if the same Evolution voltage is applied, the brightness differs from display element to display element. Further, the display contrast also differs from display element to display element. Furthermore, by the use of the display element for a long term, the change in the characteristic as describe above is a matter of concern. If there are such variations in the display element and a secular change, it is not possible to produce a desirable display even if the display element is driven under the same condition. In particular, in the dynamic driving scheme, the optimum range of the drive condition is narrow and is considerably affected by the variation and the secular change of the display element, and therefore, it is not possible to produce an excellent display under a fixed drive condition. Adjusting the drive condition periodically for each display device is possible.

The drive condition is adjusted by detecting the characteristic of the display element in relation to the display (lightness) and based on the relationship of the detected characteristic with the display (lightness). As described previously, it has been proposed to determine the drive condition in accordance with the electrostatic capacitance value hitherto and in the display device of the embodiment also, the electrostatic capacitance of the display element 10 is detected and the drive condition is adjusted so that a desirable drive condition is achieved. However, in the display device of the embodiment, the dummy cell is not used and the detection of the electrostatic capacitance and the adjustment of the drive condition are performed by directly detecting the electrostatic capacitance of the display element 10 and at the same time, by setting the display element 10 to a predetermined display state (white, black, or halftone level).

FIG. 12 is a diagram illustrating the result of measurement of the relationship between the reflectance (brightness) and the electrostatic capacitance of five samples of the display element. The electrostatic capacitance is a relative value obtained by performing measurement at 1 kHz and normalizing the lightness in the perfect planar state to 1 and the lightness in the perfect focal conic state to 0. A capacitance value between 0 and 1 corresponds to a state where the planar state and the focal conic state exist mixedly and a halftone is displayed.

As is obvious from FIG. 12, the electrostatic capacitance is at its maximum at the time of the focal conic state (lightness 0) and the electrostatic capacitance decreases monotonically as the planar state (lightness 1) is reached. From this, it is known that the change in the lightness due to the variation and secular change may be estimated based on the relative relationship of the electrostatic capacitance when a desired display is not obtained because of the variation between lots and secular change. Because of this, in the embodiment, the drive condition is adjusted so that the display contrast reaches the maximum by measuring the electrostatic capacitances of the display element in the different states displayed under different drive conditions and by associating the ratio of the measured electrostatic capacitances with the display contrast.

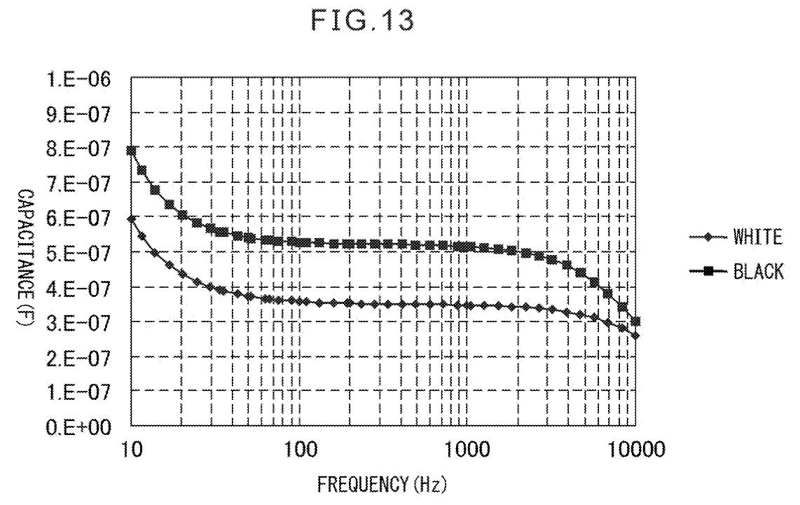

FIG. 13 is a diagram illustrating the frequency characteristic of electrostatic capacitance of the display element 10. In FIG. 13, the phenomenon in which the electrostatic capacitance is larger in the focal conic state than in the planar state lasts until about 10 kHz is reached. Further, at frequencies equal to or less than 100 Hz, the absolute value of the electrostatic capacitance becomes large. This may be considered because polarization due to the polar groups and ion components included in the liquid crystal material occurs. When the ratio of the electrostatic capacitance between the planar state and the focal conic state and the amount of current to be detected are taken into consideration, it may be thought that the use of a frequency near 1 kHz is preferable to detect the electrostatic capacitance.

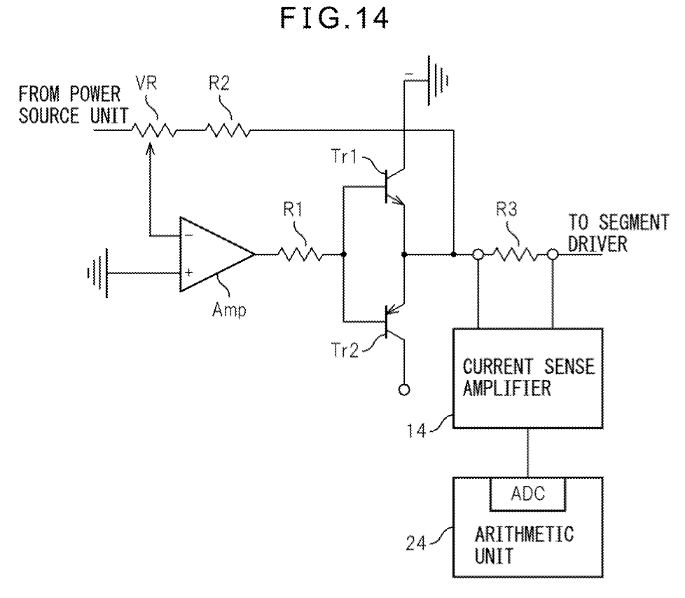

FIG. 14 is a diagram illustrating the configuration of a circuit part that outputs an electrostatic capacitance detection signal in the power source unit 13, the current sense amplifier 14, and the arithmetic unit 24. It is possible to use a general-purpose one available as the current sense amplifier 14. The power source unit 13 generates a sawtooth wave and a triangular wave by using a D/A converter etc., not illustrated schematically, and applies an original detection signal to one end of a variable resister VR. A booster circuit having an operational amplifier Amp, a resistor R1, and transistors Tr1 and Tr2 and a resistor R2 form an amplifier circuit that amplifies the original detection signal and outputs an electrostatic capacitance detection signal and stabilize the output voltage. It is possible to adjust the amplification factor of the amplifier circuit by adjusting the resistance value of the variable resistor VR. It is possible to adjust the resistance value of the variable resistor VR by adjusting, for example, the number of resistors connected by a switch and the variable resistor VR is adjusted by the control signal, etc., from the control unit 23. When the wave height of the electrostatic capacitance detection signal is not adjusted, the variable resistor VR may be a fixed resistor. In the subsequent stage of the booster circuit, a damping resistor R3 that restricts an electric current is arranged. In FIG. 14, the damping resistor R3 is used also as a sensing resistor of the current sense amplifier 14. As described previously, one end of the damping resistor R3 is connected to the unused power source terminal of the segment driver 11.

As the current sense amplifier 14, one which outputs the detected current value as an analog voltage value is used. The voltage of the voltage signal output from the current sense amplifier 14 is digitized by an AD converter (ADC) within the arithmetic unit 24 and used for calculation of the capacitance value. If a low-pass filter having an appropriate cut-off frequency is provided between the output of the current sense amplifier 14 and the AD converter, the detection precision is further improved.

The power source unit 13 generates voltages to be supplied to the segment driver 11 and the common driver 12 by a voltage divider circuit. Because the instantaneous current consumption is large in the DDS driving scheme, it is desirable for each voltage formed by the voltage divider circuit of the power source unit 13 to be output via the booster circuit having the operational amplifier Amp and the transistors Tr1 and Tr2 illustrated in FIG. 14.

Further, at the terminal part of the power source unit 13 that outputs voltages to be supplied to the segment driver 11 and the common driver 12, a smoothing capacitor having a capacitance of about several microfarads is used in many cases in the subsequent stage of the damping resistor. However, it is desirable not to provide such a smoothing capacitor at the terminal that outputs the electrostatic capacitance detection signal illustrated in FIG. 14. The reason is that when such a smoothing capacitor is provided, the combined capacitance of the electrostatic capacitance of the display element and the capacitance of the smoothing capacitor is detected as a result, and therefore, the difference in the detected values of the electrostatic capacitances between the white display, the black display, and the halftone display becomes small, the S/N ratio is reduced, and the detection precision is reduced.

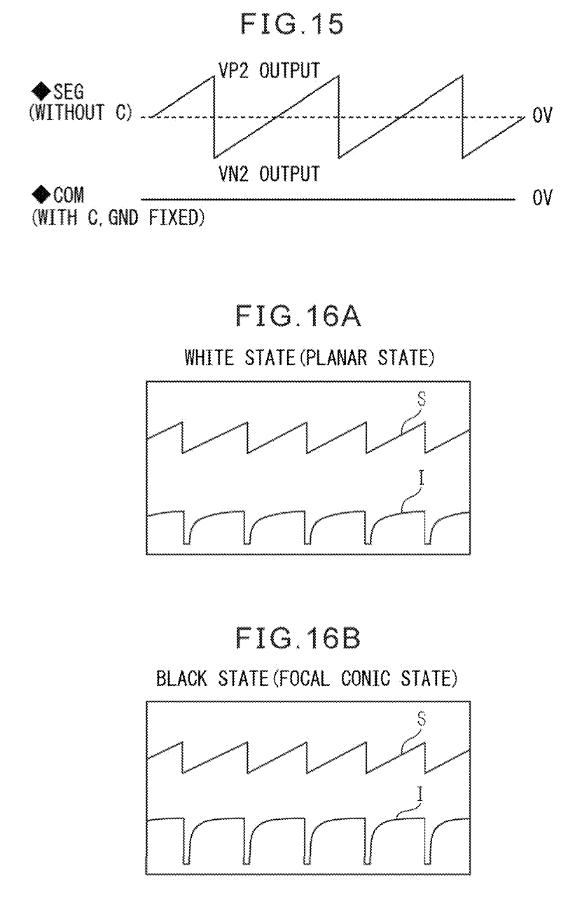

FIG. 15 is a diagram illustrating a waveform of an electrostatic capacitance detection signal to be supplied to the unused power source terminal of the segment driver 11 from the booster circuit via the damping resistor R3. In the embodiment, an electrostatic capacitance detection signal in the shape of a sawtooth wave the voltage of which changes between ±5 V is used. When applying the electrostatic capacitance detection signal to the display element, the setting is made so that the common driver 12 outputs the GND level to all the terminals and the segment driver 11 outputs the voltage of the terminal to which the electrostatic capacitance detection signal is applied to all the terminals. In this state, when the electrostatic capacitance detection signal changes as illustrated in FIG. 15, the voltage that changes in the shape of a sawtooth wave is applied to all the pixels of the display element 10. In general, the electrostatic capacitance detection signal in the shape of a sawtooth wave is generated by a DA converter, and therefore, it is desirable to provide a low-pass filter having an appropriate cut-off frequency to smooth the signal.

The electrostatic capacitance is detected by the sense amplifier 14 detecting the current value at the time of charge/discharge accompanying the application of the electrostatic capacitance detection signal to the display element 10.

It has been found that it is possible to stably detect the current at the time of charge/discharge by using the electrostatic capacitance detection signal in the shape of a sawtooth wave even in the case of the cholesteric liquid crystal the capacitance characteristic of which is inferior to that of the TFT liquid crystal.

FIG. 16A and FIG. 16B illustrate the result of the experiment of the detection of the electrostatic capacitance with the circuit configuration of FIG. 14 by using a test cell of cholesteric liquid crystal. FIG. 16A illustrates a sawtooth wave-shaped electrostatic capacitance detection signal S and an accompanying electric current I at the time of charge/discharge when all the pixels are in the white display state (planar state). FIG. 16B illustrates the sawtooth wave-shaped electrostatic capacitance detection signal S and the accompanying electric current I at the time of charge/discharge when all the pixels are in the black display state (focal conic state). In FIG. 16, the electric current I increases abruptly as the signal S increases and becomes substantially constant. When the electric current I becomes constant, the ratio between the current value in the focal conic state and the current value in the planar state is about 1.4 and it has been confirmed that the ratio substantially agrees with the ratio of electrostatic capacitance between the white and black displays illustrated in FIG. 13.

Further, a CR oscillator circuit was formed as a trial by replacing the test cell with a capacitor and the oscillation frequency was measured. As a result of that, the oscillation frequency in the planar state was about 1.4 times that in the focal conic state, however, such a case occurred frequently where the oscillation frequency varied considerably and was unstable. Consequently, in the case of the cholesteric liquid crystal, it was possible to detect the electrostatic capacitance by the electric current at the time of charge/discharge by applying the sawtooth wave-shaped electrostatic capacitance detection signal more stably than when detecting the electrostatic capacitance by detecting the oscillation frequency.

In the detection of the electrostatic capacitance described above, the electrostatic capacitances of the display element 10 at the time of the white and black displays were detected, however, it is possible to detect the electrostatic capacitance in the halftone display state by setting the display element 10 to the halftone display state. Further, in the detection of the electrostatic capacitance described above, the sawtooth wave-shaped electrostatic capacitance detection signal was used, however, it was also possible to perform the same measurement by using a triangular wave-shaped electrostatic capacitance detection signal.

Next, the adjustment method of the drive condition in the display device of the embodiment is explained.

When adjusting the drive condition of the DDS driving scheme, the condition that may be adjusted includes various kinds of condition, such as the length of each period (number of pulses) and the pulse voltage during each period. Of them, those which affect the display significantly and are easily adjusted are the pulse voltage during the evolution period (Evolution voltage), the number of pulses during the evolution period (Evolution pulse number), the length of the selection period (Selection period length: Selection pulse width), the duty of the Selection pulse during the selection period corresponding to a halftone (duty ratio), etc. In the embodiment, these are adjusted as parameters. The reason the Evolution voltage and the Evolution pulse number are adjusted is that the Evolution voltage and the Evolution pulse number are a factor that affects the contrast of display significantly. Further, the reason the Selection pulse width and the duty ratio of the Selection pulse are adjusted is that the Selection pulse width and the duty ratio may be adjusted comparatively easily and may be adjusted with precision of the factors that cause the change in gradation.

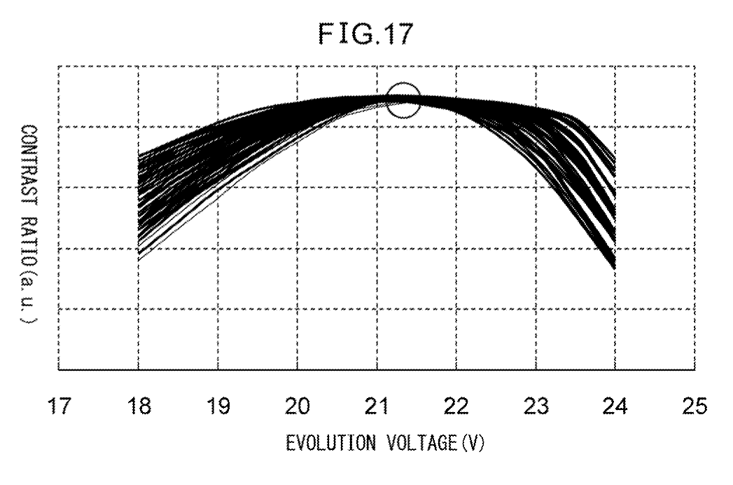

FIG. 17 is a diagram illustrating a change in contrast ratio of the white and black (on and off) displays when varying the Evolution voltage after setting the Evolution pulse number to a plurality of different values between 60 and 120 and by setting the width of the Selection pulse to a plurality of different values between 0.7 and 0.85 ms in the display device of the embodiment. That is, FIG. 17 illustrates a change in contrast ratio of the display when varying the Evolution voltage using the Evolution pulse number and the Selection pulse width as parameters.

As is obvious from FIG. 17, it is known that the maximum contrast ratio is obtained when the Evolution voltage is about 21.3 V regardless of the Evolution pulse number and the Selection pulse width. In other words, the Evolution voltage at which the maximum contrast ratio is obtained slightly depends on the Evolution pulse number and the Selection pulse width and there exists a robust value.

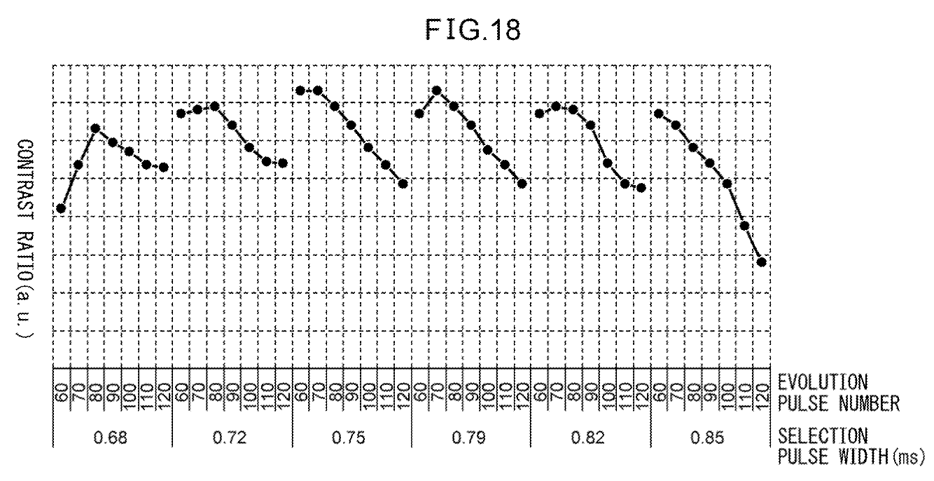

FIG. 18 is a diagram illustrating a change in contrast ratio of the white and black displays when varying the Evolution pulse number and the Selection pulse width after setting the Evolution voltage to a predetermined value near 21.3 V at which the maximum contrast ratio is obtained. Specifically, the change in contrast ratio of the white and black displays is detected when the Selection pulse width is set to 0.68 ms and the Evolution pulse number is varied in steps of 10 between 60 and 120. After this, the contrast ratio is detected by setting the Selection pulse width to 0.72 ms, 0.75 ms, 0.79 ms, 0.82 ms, and 0.85 ms and by varying the Evolution pulse number similarly.

From FIG. 18, it is known that at a certain Evolution voltage and a certain Evolution pulse number, the contrast ratio does not increase or decrease monotonically for the Selection pulse width and there exists a peak at which the contrast ratio reaches its maximum. Further, it is also known that at a certain Evolution voltage and a certain Selection pulse width, the contrast ratio does not increase or decrease monotonically for the Evolution pulse number and there exists a peak at which the contrast ratio reaches its maximum.

From the change characteristic of the contrast ratio illustrated in FIG. 17 and FIG. 18, it has been found that it is less wasteful to perform optimization of the Evolution voltage prior to the adjustment of the Evolution pulse number and the Selection pulse width. Further, it has been found that there exists a peak of the contrast ratio for the adjustment parameters, and therefore, by the bisection method that requires the monotonically increasing (or decreasing) characteristic, the contrast ratio does not necessarily reach its maximum. In the embodiment, the above is taken into consideration and the drive condition of the DDS driving scheme is adjusted as follows.

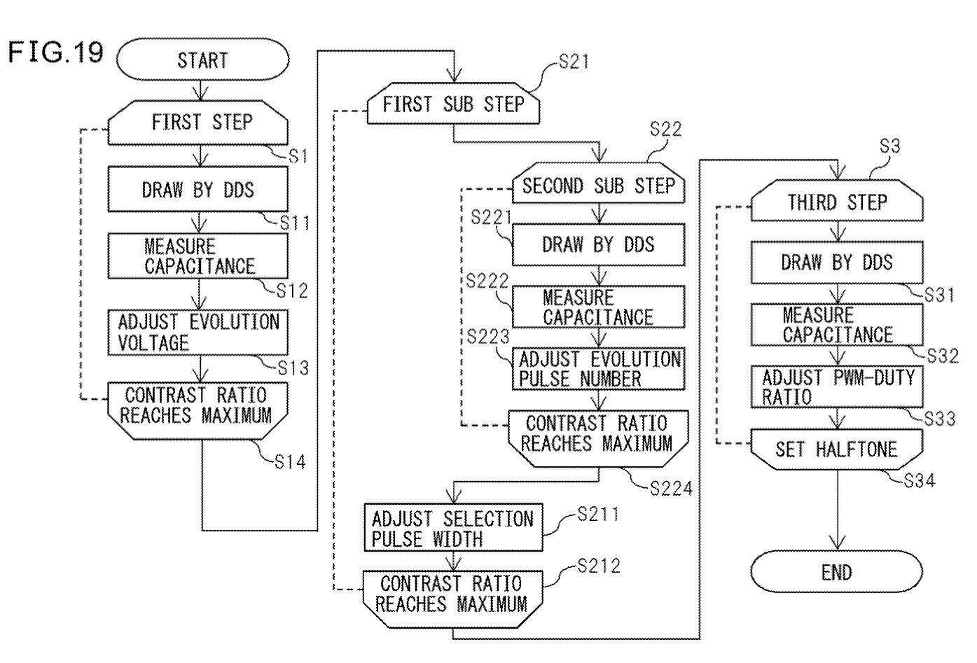

FIG. 19 is a flowchart illustrating adjustment processing of the drive condition in the display device of the embodiment. The adjustment processing includes first step S1, a second step, and third step S3 and the second step further includes first sub step S21 and second sub step S22.

In first step S1, the Evolution voltage is searched for.

In step S11 of first step S1, drawing is performed by the dynamic driving scheme (DDS) so that a half of the display element 10 is in the white display state (planar state) and the other half is in the black display state (focal conic state). At this time, as the parameters other than the Evolution voltage, temporary values are used and as the temporary values, for example, default values of the panel characteristic are used. In the manufacture of panel, the design characteristic obtained when an ideal manufacture without any variation is performed is the default value.

In step S12 of first step S1, by the capacitance detection method explained in FIG. 14 and FIG. 15, the capacitance values of the portion in the white display state and the portion in the black display state of the display element 10 are measured. The search index in first step S1 is the Evolution voltage at which the contrast ratio reaches its maximum. The brightness of the display element 10 has a correlation with the electrostatic capacitance, and therefore, it is possible to use the electrostatic capacitance ratio in place of the contrast ratio.

In step S12 of first step S1, the Evolution voltage is adjusted in the direction in which the contrast ratio is increased. As the search algorithm of the embodiment, a system that does not overlook a peak in the search for the characteristic having a peak is desirable and for example, the use of a three-way classification is preferable.

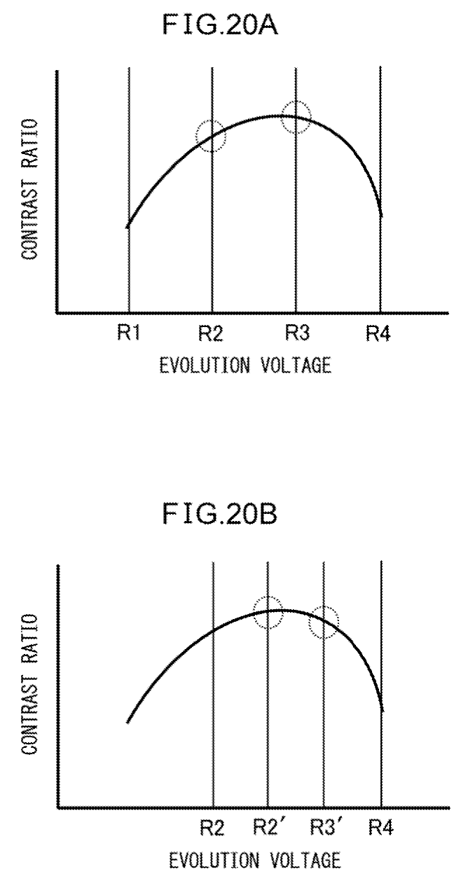

FIG. 20A and FIG. 20B are diagrams explaining the three-way classification.

As illustrated in FIG. 20A, the search region from a lower limit R1 to an upper limit R4 is divided into three regions by R1, R2, R3, and R4. The contrast ratios of the two points R2 and R3 inside of the region are measured. The search region is narrowed so that the larger value remains (R3 in FIG. 20A) as the result of the measurement, and the narrowed region is taken to be the next search region.

When the region is narrowed so that R3 remains, the next search region is a region between R2 and R4 as illustrated in FIG. 20B. By repeating the same processing in the narrowed search range, the search range is narrowed so that the peak remains and thereby the target peak characteristic is obtained.

Consequently, in order to perform one time adjustment of the Evolution voltage, the processing to draw the display in which a half is the white display and the other half is the black display is repeatedly performed and then, the processing to calculate the contrast ratio by measuring the capacitances, respectively, for the four different kinds of Evolution voltage. Consequently, steps S11 and S12 are repeated four times in fact.

In step S14 of first step S1, whether the contrast ratio has reached its maximum is determined and first step S1 is repeated until the maximum is reached. The determination that the contrast ratio has reached its maximum is made when, for example, the difference in the contrast ratio between the two points R2 and R3 inside of the region becomes a predetermined value or less, and, for example, 1% or less of the contrast ratio in R2 or R3, and then, step S1 is exited after it is determined that the maximum contrast ratio has been reached.

By the characteristic found from the change in characteristic illustrated in FIG. 17, the Evolution voltage determined in first step S1 slightly depends on the Evolution line number and the Selection pulse width, and therefore, it is possible to use the Evolution voltage regardless of the subsequent search result.

In second step, a search for the Evolution pulse number and the Selection pulse width is made by the three-way classification using the Evolution voltage detected in first step S1. In the second step, a value at which the contrast ratio reaches its maximum is searched for in the same manner as that in first step S1 by fixing the Evolution voltage to a searched value and using the Evolution pulse number and the Selection pulse width as parameters. At this time, it is possible to optimize the search by including the Evolution pulse number search loop in the Selection pulse width loop and by performing the search using the double loop. The order of the double loop is not limited and it may also be possible to include the Selection pulse width search loop in the Evolution pulse number search loop.

The DDS drawing processing in step S211 of the second step, the measurement of capacitance in S222, the adjustment of the Evolution pulse number and the Selection pulse width in S223 and S211, and the determination of the maximum contrast ratio in S224 and S212 are the same as those in step S1.

The Evolution voltage detected in first step S1 is a robust value slightly depending on the result of the second step, and therefore, it is possible to obtain the maximum contrast ratio using the Evolution voltage, the Evolution pulse number, and the Selection pulse width obtained in the first and second steps.

In third step S3, adjustment of the halftone characteristic is made by searching for a target value of the duty ratio of the Selection pulse (for example, when the halftone is half the target value, the target electrostatic capacitance is 50%). It is assumed that as the minimum and maximum electrostatic capacitances, the values when the maximum contrast ratio is obtained in the second step are made use of, however, it may also be possible to perform measurement separately.

In third step S3, the relationship of the duty ratio of the Selection pulse is set by using the Evolution voltage, the Evolution pulse number, and the Selection pulse width determined in the first and second steps. The change in brightness relative to the change in the duty ratio of the Selection pulse increases or decreases monotonically, and therefore, it is preferable to apply the bisection method.

In step S31, the entire screen of the display element 10 is brought into the target halftone display state that displays any of the halftones to be displayed.

In step S32, the electrostatic capacitance of the display element 10 in the target halftone display state set in step S31 is measured.

In step S33, the target electrostatic capacitance value corresponding to the target halftone display state is calculated and the electrostatic capacitance value measured in step S32 is compared with the target electrostatic capacitance value. Then, based on the comparison result, the duty ratio of the Selection pulse is adjusted so that the measured electrostatic capacitance values becomes the target electrostatic capacitance value.

When the measured electrostatic capacitance value obtained in step S32 approaches the target electrostatic capacitance value by repeating steps S31 to S33, third step S3 is exited.

The control unit 23 stores the Evolution voltage, the Evolution pulse number, the Selection pulse width, and the duty ratio of the Selection pulse determined as described above as a new drive condition and controls each unit in accordance with the determined drive condition after the drive condition adjustment mode is completed.

In general, when adjusting the drive condition, it may be thought to find a characteristic curve of brightness versus a parameter to be changed and to set the parameter to an optimum value of the characteristic curve. For example, it may be possible to find a characteristic of brightness versus the Evolution voltage and to determine the Evolution voltage at which the brightness in the range of change reaches the maximum value (100%) and the minimum value (0%). Then, the duty ratio of the Selection pulse is set in accordance with the halftone level as a result. However, by this method, it is possible to adjust only the Evolution voltage at which the brightness reaches the maximum value and the minimum value, and it is not possible to adjust the other parameters, for example, the Evolution pulse number, the Selection pulse length, etc., because their relationship with the Evolution voltage is not clear.

With the dynamic driving scheme, the number of parameters to be adjusted is large and it takes long processing time if all the parameters are combined. Because of this, if the drive condition is searched for after limiting the adjustment parameters and finding the above-mentioned characteristic curve, the adjustment time becomes long. Further, if the parameters are limited erroneously, an optimum solution is not obtained. Furthermore, the limited parameters premise that they do not change with time. In fact, however, a plurality of parameters considerably affects the display significantly and these parameters change with time, and therefore, it is desirable to set an optimum drive condition by integrating the plurality of parameters.

In particular, as to the color display element in which the cholesteric liquid crystal display elements in the three RGB layers are stacked as in FIG. 2, it has been found that there is a difference in the optimum Evolution voltage and in the Evolution pulse number between the display elements in respective colors. Because of this, for the color display element, the drive condition is determined in view of the balance of the display quality of the display elements in three colors and the actual situation is such that the condition range in which the display elements in the RGB layers may be driven at the same time is narrow. Because of this, if the fixed values of the parameters that are determined in advance are erroneously selected, an optimum solution is not obtained by the subsequent adjustment.

In contrast to this, with the adjustment of the drive condition of the display device of the embodiment, it is possible to sequentially determine the plurality of parameters, such as the Evolution voltage, the Evolution pulse number, and the Selection pulse length based on the interrelationship. Further, it is possible to use the contrast ratio, which is an adjustment index, as it is and to determine the plurality of parameters so that the contrast ratio reaches its maximum, and the relationship with the display quality is direct, and therefore, the adjustment is unlikely to be affected by the influence of errors. Consequently, with the cholesteric liquid crystal display device of the embodiment that was manufactured as a trial, a contrast ratio of 8.6 was obtained and the improvement in display quality was confirmed.

It is preferable for the control unit 23 to perform the drive condition adjustment mode without exception when the display device is used for the first time, such as at the time of shipping of the product, and to automatically perform periodically after that, for example, at the frequency of about once a month. The drive condition is considerably changed when the electrostatic capacitance values at the time of the white display and the black display change considerably and the Evolution voltages corresponding to the white display and the black display change considerably.

Because of this, the control unit 23 performs the above-mentioned drive condition adjustment processing when the display device is used for the first time and determines and stores the Evolution voltage, the Evolution pulse, the Selection pulse length, and the duty ratio of the Selection pulse. At this time, the electrostatic capacitance values at the time of the white display and the black display are also measured and stored. After that, the electrostatic capacitance values at the time of the white display and the black display are measured periodically and when differences from the stored values are smaller than the threshold values, the drive condition adjustment processing is not performed and the stored drive condition is used as it is. If the differences between the measured electrostatic capacitance values at the time of the white display and the black display and the stored values become larger than the threshold values, the drive condition adjustment processing is performed. Then, it may also be possible to update the drive condition and the electrostatic capacitance values at the time of the white display and the black display to newly determined and measured values and to use these values after that.

According to embodiments, it is possible to detect an actual electrostatic capacitance of a cholesteric display element without providing extra pixels, such as dummy pixels, and to obtain an excellent display at all times by setting an optimum drive condition in accordance with the detection result.

As explained above, with the display device of the embodiment, it is possible to adjust the drive condition to an optimum one including a plurality of parameters.

All examples and conditional language provided herein are intended for pedagogical purposes of aiding the reader in understanding the invention and the concepts contributed by the inventor to furthering the art, and are to be construed as limitations to such specifically recited examples and conditions, nor does the organization of such examples in the specification relate to a illustrating of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A cholesteric liquid crystal display device comprising:
a passive matrix cholesteric liquid crystal display element;
a drive circuit configured to apply a voltage pulse by a dynamic driving scheme to the cholesteric liquid crystal display element so as to produce a display in accordance with display data;
an electrostatic capacitance detection circuit configured to detect the electrostatic capacitance exhibited by the display element; and
a drive condition adjustment circuit configured to set a display state by driving the display element under a predetermined drive condition and then to adjust the drive condition of the display element based on the electrostatic capacitance of the display element exhibiting the display state detected by the electrostatic capacitance detection circuit, wherein
the drive condition adjustment circuit searches for and determines an optimum evolution voltage with a temporarily-determined number of pulses during an evolution period and then searches for and determines an optimum value of the number of pulses during the evolution period with the determined evolution voltage.

2. The cholesteric liquid crystal display device according to claim 1, wherein
the drive condition adjustment circuit searches for and determines the optimum evolution voltage and the selection period length after temporarily determining the selection period length when searching for and determining the optimum evolution voltage, and then searches for and determines the optimum values of the number of pulses during the evolution period and the selection period length with the determined evolution voltage.

3. The cholesteric liquid crystal display device according to claim 2, wherein
the drive condition adjustment circuit further searches for and determines the optimum value of the pulse duty during the selection period corresponding to a halftone with the determined evolution voltage, the number of pulses during the evolution period, and the selection period length.

4. The cholesteric liquid crystal display device according to claim 1, wherein
the drive condition adjustment circuit automatically adjusts the drive condition of the display element so that the contrast ratio becomes the maximum by associating the electrostatic capacitances detected in at least two or more different display states with the contrast ratio.

5. The cholesteric liquid crystal display device according to claim 2, wherein
the drive condition adjustment circuit automatically adjusts the drive condition of the display element so that the contrast ratio becomes the maximum by associating the electrostatic capacitances detected in at least two or more different display states with the contrast ratio.

6. The cholesteric liquid crystal display device according to claim 3, wherein
the drive condition adjustment circuit automatically adjusts the drive condition of the display element so that the contrast ratio becomes the maximum by associating the electrostatic capacitances detected in at least two or more different display states with the contrast ratio.

7. The cholesteric liquid crystal display device according to claim 1, wherein
the electrostatic capacitance detection circuit comprises:
a current detection waveform application circuit configured to generate a signal having a current detection waveform and to apply the signal to the display element; and
a current detection circuit configured to detect the current value to the display element when the signal having the current detection waveform is applied.

8. The cholesteric liquid crystal display device according to claim 2, wherein
the electrostatic capacitance detection circuit comprises:
a current detection waveform application circuit configured to generate a signal having a current detection waveform and to apply the signal to the display element; and
a current detection circuit configured to detect the current value to the display element when the signal having the current detection waveform is applied.

9. The cholesteric liquid crystal display device according to claim 3, wherein
the electrostatic capacitance detection circuit comprises:
a current detection waveform application circuit configured to generate a signal having a current detection waveform and to apply the signal to the display element; and
a current detection circuit configured to detect the current value to the display element when the signal having the current detection waveform is applied.

10. The cholesteric liquid crystal display device according to claim 4, wherein
the electrostatic capacitance detection circuit comprises:
a current detection waveform application circuit configured to generate a signal having a current detection waveform and to apply the signal to the display element; and
a current detection circuit configured to detect the current value to the display element when the signal having the current detection waveform is applied.

11. The cholesteric liquid crystal display device according to claim 7, wherein
the current detection circuit is arranged so as to measure an electric current to be supplied to a segment driver configured to drive the display element.

12. The cholesteric liquid crystal display device according to claim 1, wherein
the drive condition adjustment circuit searches for an optimum value by the three-way classification.

13. The cholesteric liquid crystal display device according to claim 1, wherein
the drive condition adjustment circuit performs the adjustment operation of the drive condition of the display element periodically.

14. A method for controlling the drive of a cholesteric liquid crystal display element in which a voltage pulse is applied to a passive matrix type cholesteric liquid crystal display element by a dynamic driving scheme, the method comprising:
searching for and determining an optimum evolution voltage with a temporarily-determined number of pulses during an evolution period and then searching for and determining an optimum value of the number of pulses during the evolution period with the determined evolution voltage; and
determining the optimum values of the evolution voltage and the number of pulses during the evolution period so that the contrast ratio becomes the maximum value by associating the electrostatic capacitances detected in at least two or more different display states with the contrast ratio.

15. The method for controlling the drive of a cholesteric liquid crystal display element according to claim 14, further comprising:
searching for and determining the optimum evolution voltage and the selection period length after temporarily determining the selection period length when searching for and determining the optimum evolution voltage, and then searching for and determining the optimum values of the number of pulses during the evolution period and the selection period length with the determined evolution voltage.

16. The method for controlling the drive of a cholesteric liquid crystal display element according to claim 15, further comprising:
determining the optimum value of the pulse duty of the selection period corresponding to a halftone so that the contrast ratio becomes the maximum with the determined evolution voltage, the number of pulses during the evolution period, and the selection period length.
